(19) United States
(12) Patent Application Publication
(10) Pub. No.: US 2015/0223110 A1
(43) Pub. Date: Aug. 6, 2015

(54) ROBUST VOICE-ACTIVATED FLOOR CONTROL

(71) Applicant: QUALCOMM Incorporated, San Diego, CA (US)

(72) Inventors: Mark Aaron LINDNER, Verona, WI (US); Kenneth Ilagan BENAVENTE, Solana Beach, CA (US)

(73) Assignee: QUALCOMM Incorporated, San Diego, CA (US)

(21) Appl. No.: 14/173,620

(22) Filed: Feb. 5, 2014

(51) Int. Cl. H04W 28/04; H04W 24/08; H04W 4/08

(52) U.S. Cl. CPC H04W 28/044; H04W 4/08; H04W 24/08; H04W 4/10

(57) ABSTRACT

The disclosure relates to a voice-activated floor control mechanism that may be used in push-to-talk (PTT) communications. In particular, a client device may compare an ambient noise bitrate during an idle state in a PTT call to a threshold value that indicates normal background noise levels and trigger a floor request in response to the ambient noise bitrate during the idle state exceeding and remaining above the threshold value until a timer expires. Furthermore, the voice-activated floor control mechanism may adjust the timer value or other criteria used to trigger the floor request based on a conversational context associated with the PTT call, infer whether or not the floor request was intended, stream buffered audible frames in response to receiving a floor grant, and determine whether to release the floor grant, among other things.

### TECHNICAL FIELD

The disclosure generally relates to a robust voice-activated floor control mechanism that may be used in push-to-talk (PTT) communications, and in particular, to techniques that may be used to request a floor, stream audio data during a floor grant, and release a floor based on user intent that may be inferred from monitored audio data.

### BACKGROUND

In wireless telecommunication devices, which may generally include cellular phones, personal digital assistants (PDAs), mini-laptops, and advanced pagers, among others, the devices typically bridge telephone calls through existing cellular telephone networks and pass data packets across the network to communicate over long distances. These wireless telecommunications devices often have limited to significant data processing and computing capability, and can accordingly send and receive software programs, in addition to voice, across the telephone network.

There exists a wireless telecommunication service generically referred to as “Push-To-Talk” (PTT) capability that can provide a quick one-to-one or one-to-many communication, wherein a carrier commonly establishes the specific recipient devices for wireless device communicating in a PTT group. For example, a PTT communication connection may typically be initiated in response to a single button-push on a wireless device, which may activate a half-duplex link between the speaker and each member device within the group, wherein the device can subsequently receive incoming PTT transmissions once the button is released. In some arrangements, the PTT speaker will have the “floor” whereby no other group member can speak while the speaker holds the floor. Accordingly, once the speaker holding the floor releases the PTT button, any other individual member within the group can engage a PTT button in order to request and thereby take the floor.

However, group communications that involve taking and releasing an audio “floor” typically requires group members to manipulate a floor request control (e.g., a PTT button) in a frequent and timely manner, wherein the PTT button or other floor request control may not be easily reachable or may not even exist in certain scenarios. For example, the PTT button may not be easily reachable if the user has their wireless device in their pocket, on their desk, in a locked state, while driving, etc., while certain wireless devices may not have a PTT button despite supporting PTT communication (e.g., a smartwatch running a PTT client). Furthermore, even if a PTT button does exist and can be reached, users may nonetheless need or otherwise benefit from a more natural, conversational method to take and release the audio floor. Although certain existing efforts have been made to employ voice activation based on speech recognition and well-known commands (e.g., in command-and-control systems) and/or transitions between silence and audio to trigger certain actions or enable certain features, the existing efforts tend to exhibit various problems. For example, fixed voice activation commands can interrupt natural speech patterns due to the rigid requirements associated with the manner in which requests must be spoken, and moreover, many existing speech recognition mechanisms tend to be unreliable and/or difficult to use. Furthermore, voice activation mechanisms that rely solely or primarily on detecting transitions between silence and sound can be error prone and result in false positives.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments disclosed herein in a simplified form to precede the detailed description presented below.

According to various aspects of the disclosure, a robust voice-activated floor control mechanism may be provided to request a floor, stream audio data during a floor grant, and release a floor based on user intent that may be inferred from monitored audio data during push-to-talk (PTT) communications. In particular, the voice-activated floor control mechanism may generally activate a microphone or other audio capture device on a client device to listen to ambient noise during idle states in a PTT call and compare the bitrate associated with the ambient noise during the idle states to a threshold value that indicates normal background noise levels. For example, when an in-progress PTT call does not exist, or during idle states in an in-progress PTT call, the voice-activated floor control mechanism may listen to the ambient noise and compute an average bitrate from the vocoder, wherein silence or normal background noise levels may generally result in the bitrate averaging to the “eighth rate” or comfort noise value. Furthermore, the voice-activated floor control mechanism may filter out noise that does not fall within a frequency range typically associated with voice and/or other background noise that may not represent a user speaking (e.g., sound attributable to radio, music, public background conversations, etc.). Accordingly, the threshold value may represent a standing average bitrate computed from an average bitrate over a particular duration, wherein the voice-activated floor control mechanism may trigger a floor request in response to the ambient noise bitrate during a particular idle state exceeding the threshold value and continuing to exceed the threshold value until a timer expires. Moreover, as will be described in further detail below, the voice-activated floor control mechanism may adjust the timer value or other criteria used to trigger the floor request based on a conversational context associated with the PTT call, infer whether or not the floor request was actually intended, employ various techniques to stream buffered audible frames in response to receiving a floor grant and/or discard buffered audible frames in response to inferring that a floor request was not intended, and determine whether to release the floor grant (e.g., based on the ambient noise bitrate dropping below the threshold value and staying below the threshold value until a floor release timer value expires), among other things.

According to one aspect of the disclosure, a method for voice-activated PTT floor control may comprise listening to ambient noise during an idle state in a PTT call, comparing a bitrate associated with the ambient noise during the idle state to a threshold value that indicates normal background noise levels, and triggering a request to take a floor in the PTT call in response to the bitrate associated with the ambient noise during the idle state exceeding the threshold value and continuing to exceed the threshold value until a floor request timer expires. Furthermore, in one embodiment, the method may further comprise shortening the floor request timer in response to determining that a participant in the PTT call that was holding the floor has released the floor and/or increasing the floor request timer in response to determining that the released floor has remained available for a predetermined time period without another participant taking the floor. Alternatively (or additionally), the floor request timer may be shortened in response to the ambient noise bitrate that triggered the floor request exceeding the threshold value during a period after a first participant released the floor and prior to a second participant requesting and taking the floor (i.e., the second participant beat the user to the floor), in response to recognizing certain key words that match a conversational context associated with the PTT call, based on a conversational context indicating a next logical user to have a turn to speak in the PTT call after a first participant releases the floor, or based on other suitable criteria.

According to one aspect of the disclosure, the method may further comprise gathering audible frames that correspond to the ambient noise in a buffer and resetting the audible frames gathered in the buffer in response to determining that the ambient noise does not indicate an intent to request the floor. Alternatively, in response to the ambient noise triggering the floor request to take the floor, one or more latency shredding techniques may be applied to the buffered audible frames, which may then be streamed from a start of the buffer in response to receiving a floor grant. In the latter case, the method may further comprise continuing to listen to the ambient noise during the floor grant and triggering a request to release the floor in response to the ambient noise bitrate during the floor grant dropping below a threshold value that indicates a comfort noise level and staying below the threshold value until a first floor release timer expires. Alternatively, the floor release may be triggered if the ambient noise bitrate during the floor grant drops below and stays below the above-mentioned threshold value that indicates normal background noise levels until a second floor release timer expires, wherein the second floor release timer may be longer than the first floor release timer, and wherein various techniques may be used to adjust the first and/or second floor release timers based on the conversational context associated with the PTT call.

According to one aspect of the disclosure, an apparatus for voice-activated PTT floor control may comprise means for listening to ambient noise during an idle state in a PTT call, means for comparing a bitrate associated with the ambient noise during the idle state to a threshold value that indicates normal background noise levels, and means for triggering a request to take a floor in the PTT call in response to the bitrate associated with the ambient noise during the idle state exceeding the threshold value and continuing to exceed the threshold value until a floor request timer expires. Furthermore, in one embodiment, the apparatus may further comprise means for shortening the floor request timer in response to determining that a participant in the PTT call that was holding the floor has released the floor and/or means for increasing the floor request timer in response to determining that the released floor has remained available for a predetermined time period without another participant taking the floor. Alternatively (or additionally), the floor request timer may be shortened in response to the ambient noise bitrate that triggered the floor request exceeding the threshold value during a period after a first participant released the floor and prior to a second participant requesting and taking the floor (i.e., the second participant beat the user to the floor), in response to recognizing certain key words that match a conversational context associated with the PTT call, based on a conversational context indicating a next logical user to have a turn to speak in the PTT call after a first participant releases the floor, or based on other suitable criteria.

According to one aspect of the disclosure, the apparatus may further comprise means for gathering audible frames that correspond to the ambient noise in a buffer and means for resetting the buffered audible frames in response to determining that the ambient noise does not indicate an intent to request the floor. Furthermore, the apparatus may comprise means for applying one or more latency shredding techniques to the buffered audible frames in response to the ambient noise triggering the floor request to take the floor, wherein the apparatus may comprise means for streaming the buffered audible frames from a start of the buffer in response to receiving a floor grant. In the latter case, the means for listening may continue to listen to the ambient noise during the floor grant and the means for triggering may trigger a request to release the floor in response to the ambient noise bitrate during the floor grant dropping below a threshold value that indicates a comfort noise level and staying below the threshold value until a first floor release timer expires. Alternatively, the floor release may be triggered if the ambient noise bitrate during the floor grant drops below and stays below the above-mentioned threshold value that indicates normal background noise levels until a second floor release timer expires, wherein the second floor release timer may be longer than the first floor release timer, and wherein various techniques may be used to adjust the first and/or second floor release timers based on the conversational context associated with the PTT call.

According to one aspect of the disclosure, an apparatus for voice-activated PTT floor control may comprise an audio capture device configured to capture ambient noise during an idle state in a PTT call and one or more processors configured to compare a bitrate associated with the ambient noise during the idle state to a threshold value that indicates normal background noise levels and trigger a request to take a floor in the PTT call in response to the ambient noise bitrate during the idle state exceeding the threshold value and continuing to exceed the threshold value until a floor request timer expires.

According to one aspect of the disclosure, a computer-readable storage medium may have computer-executable instructions recorded thereon, wherein executing the computer-executable instructions on one or more processors may cause the one or more processors to listen to ambient noise during an idle state in a PTT call, compare a bitrate associated with the ambient noise during the idle state to a threshold value that indicates normal background noise levels, and trigger a request to take a floor in the PTT call in response to the bitrate associated with the ambient noise during the idle state exceeding and staying above the threshold value until a floor request timer expires.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary block diagram corresponding to a wireless network with a push-to-talk (PTT) group in which various wireless telecommunication devices may communicate with a group communication server and other computer devices across the wireless network, according to one aspect of the disclosure.

FIG. 2 illustrates an exemplary block diagram corresponding to one embodiment in which a wireless network in a common cellular configuration may have a group communication server that can control communications among the wireless telecommunication devices in a PTT group, according to one aspect of the disclosure.

FIG. 3 illustrates an exemplary block diagram corresponding to one embodiment associated with wireless telecommunication devices having computer platforms that can support PTT capabilities, according to one aspect of the disclosure.

FIG. 4 illustrates an exemplary block diagram corresponding to one embodiment associated with various software layers that may be included in a group communication application having a PTT client and a voice-activated floor control module, according to one aspect of the disclosure.

FIG. 5 illustrates an exemplary call flow corresponding to one embodiment in which a wireless communication device may receive a floor grant in response to initiating a PTT group communication and subsequently release the floor to allow other PTT group members to take the floor, according to one aspect of the disclosure.

FIG. 6A illustrates an exemplary call flow corresponding to one embodiment in which a wireless communication device engaged in a PTT group communication may utilize a voice-activated floor control mechanism to request the floor, control audio transmissions while the floor has been granted to the wireless communication device, and subsequently release the floor, according to one aspect of the disclosure.

FIG. 6B illustrates another exemplary call flow corresponding to one embodiment in which a voice-activated floor control mechanism may sample and buffer audio during an idle state in a PTT group communication and discard the buffered audio in response to a determination that the sampled audio does not indicate an intended floor request, according to one aspect of the disclosure.

FIGS. 7A-C illustrate exemplary timing diagrams corresponding to various embodiments in which the voice-activated floor control mechanism may adjust a timer value used to trigger a floor request based on a conversational context associated with a PTT group communication, according to various aspects of the disclosure.

FIG. 8 illustrates an exemplary block diagram corresponding to one embodiment associated with a base station and a wireless communication device that may communicate with each other in relation to a PTT group communication, according to one aspect of the disclosure.

FIG. 9 illustrates an exemplary block diagram corresponding to one embodiment associated with a server (e.g., a group communication server) that may control communications among wireless telecommunication devices in a designated PTT group, according to one aspect of the disclosure.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation. Further, as used herein the term group communication, push-to-talk, or similar variations are meant to refer to a server arbitrated service between two or more devices.

The terminology used herein is for the purpose of describing particular aspects only and is not intended to be limiting of aspects of the disclosure. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms actions to be performed by, for example, elements of a computing device. It will be recognized that various actions described herein can be performed by specific circuits (e.g., an application specific integrated circuit (ASIC) or another suitable circuit), by program instructions being executed by one or more processors, or combinations thereof. Additionally, the actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In this description, the terms “communication device,” “wireless device,” “wireless communications device,” “push-to-talk communication device” (or “PTT communication device”), “handheld device,” “mobile device,” and “handset” are used interchangeably. The terms “call” and “communication” are also used interchangeably. The term “application” as used herein is intended to encompass executable and non-executable software files, raw data, aggregated data, patches, and other code segments.

The techniques described herein may be used for various cellular communication systems such as CDMA, TDMA, FDMA, OFDMA and SC-FDMA systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2). For clarity, certain aspects of the techniques are described below for LTE, and LTE terminology is used in much of the description below.

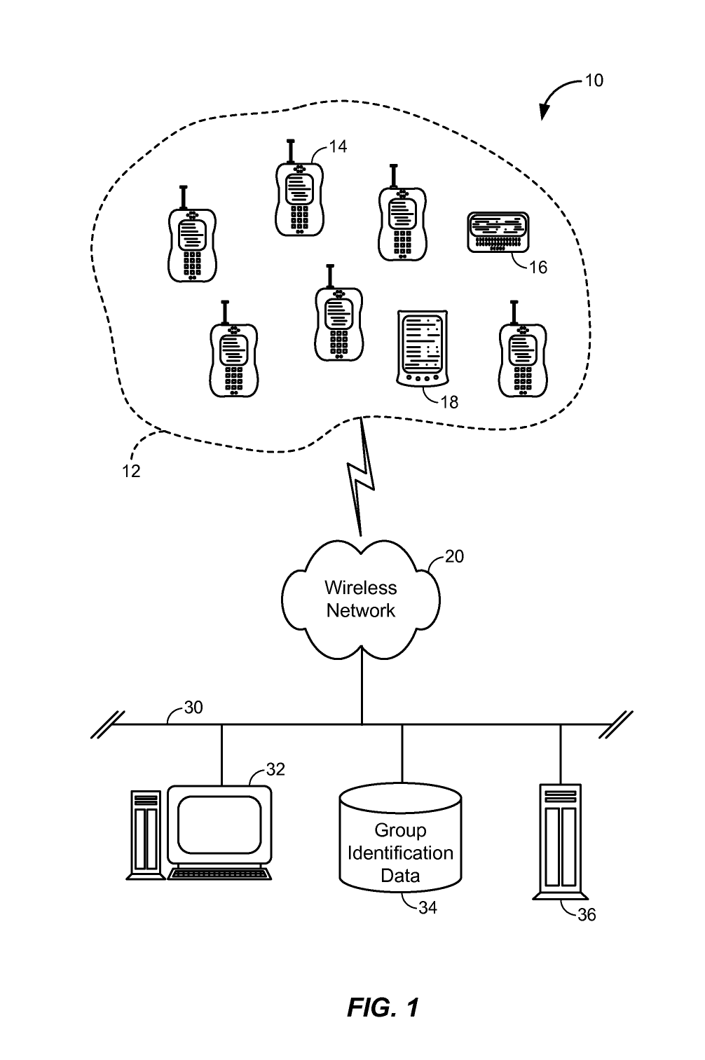

According to one aspect of the disclosure, FIG. 1 illustrates an exemplary block diagram corresponding to a system in which a communication group 12 may include various wireless telecommunication devices, such as a wireless telephone 14, a smart pager 16, and a personal digital assistant (PDA) 18, may communicate with a group communication server 32 and other computer devices across a wireless network 20. In the system 10 shown therein, each wireless telecommunication device 14, 16, 18, etc. can selectively and directly communicate across the wireless communication network 20 with a target set that includes one or more other wireless telecommunication devices in the communication group 12. For example, the target set associated with the mobile telephone 14 can be all devices in the communication group 12 or a subset thereof, such as pager 16 and PDA 18.

In one embodiment, a wireless telecommunication device in the communication group 12 (e.g., mobile telephone 14) may send a flag to at least the group communication server 32, which may reside on a server-side local area network (LAN) 30 across the wireless network 20, to indicate that the wireless device is present (i.e., accessible) on the wireless network 20. The group communication server 32 can then share the presence information with the target set associated with the wireless telecommunication device and/or share the presence information associated with the wireless telecommunication device with other computer devices that reside on the server-side LAN 30 or are otherwise accessible via the wireless network 20. The group communication server 32 can have an attached or accessible database 34 to store group identification data associated with the wireless devices in the communication group 12. Furthermore, in one embodiment, a data store 36, shown in FIG. 1 as a file management server, may be present on the server-side LAN 30. However, those skilled in the art will appreciate that the computer components resident on the server-side LAN 30, accessible via the wireless network 20, within the communication group 12, or the Internet generally, are not limited to the exemplary components shown in FIG. 1.

In one embodiment, direct communication (e.g., a PTT communication) can be established through half-duplex channels between one or more communicating wireless telecommunication devices 14, 16, 18, etc. and any other wireless telecommunication devices in the target set associated therewith. Furthermore, the group communication server 32 can attempt to bridge the requested direct communication with the target set if at least one wireless telecommunication device in the target set have informed the group communication server 32 of their presence on the wireless network 20. Alternatively (or additionally), the group communication server 32 can inform the wireless telecommunication device 14, 16, 18, etc. that a direct communication to the target set 12 could not be bridged if no wireless telecommunication devices (or at least one wireless telecommunication device) in the target set have not informed the group communication server 32 of their presence on the wireless network 20. Further, while FIG. 1 shows the group communication server 32 as having the attached database 34 with group identification data, the group communication server 32 can have the group identification data resident thereupon, and perform all storage functions described herein locally.

In overview, the system 10 shown in FIG. 1 may include at least one wireless communication device (e.g., mobile telephone 14) that is a member in the communication group 12 that communicate with each other in direct group communications across the wireless communication network 20, wherein the at least one wireless communication device may selectively send group-directed media to other members of the communication group 12 and at least one group communication server 32 may store information on communication groups 12 on the wireless communication network 20, including the information about the identities associated with specific member wireless communication devices in the communication groups 12. The group communication server 32 may further selectively receive group-directed media from sending wireless communication devices (e.g., mobile telephone 14) in the communication group 12 and send the received group-directed media to the other member wireless communication devices in the communication group 12.

Additionally, in one embodiment, the system 10 can further include a data store 36 in communication with the group communication server 32, which may be configured to send group-directed media to the data store 36. The data store 36 may thereby receive the group-designated media from the wireless communication device (e.g., mobile phone 14) and selectively permit members in the communication group 12 to access the group-directed media stored therein across the wireless communication network 20. Furthermore, the group-directed media can be any suitable media type, which may include, without limitation, graphic media or pictures (e.g., in JPEG, TIF, and other formats), audio files (e.g., in MP3, MP4, WAV, and other formats, etc.), streaming media (e.g., PowerPoint files, MOV files, and other multimedia application files), and other application-specific data or custom application data, which may either reside at the wireless communication device 14, 16, 18, etc. or in communication therewith. The group-directed media can also be an interactive session on another computer device on the wireless communication network 20 (e.g., a game hosted on data store 36 or a private bulletin board), half-duplex video conferencing among members in the communication group 12 (e.g., where a picture corresponding to the speaker may be broadcast to the other group members in substantially real-time or according to a suitable delay), location information (e.g., GPS coordinates or network locations), or other suitable media types.

Furthermore, in one embodiment, one or more wireless communication device 14, 16, 18, etc. in the communication group 12 may implement a voice-activated floor control mechanism that may cause the one or more wireless communication device 14, 16, 18, etc. to trigger a floor request, stream audio data during a period when the floor has been granted to the one or more wireless communication device 14, 16, 18, etc., and subsequently release the floor granted to the one or more wireless communication device 14, 16, 18, etc. For example, as will be described in further detail herein, the voice-activated floor control mechanism may activate a microphone to listen to ambient noise during an idle state in a PTT group communication, whereby audible frames may be generated and stored in a random access memory (RAM) or other suitable buffer while performing further analysis in parallel. Accordingly, the collected ambient noise may be analyzed to determine whether a user may be speaking with the intention to take the floor, in response to which the voice-activated floor control mechanism may take action to trigger a floor request in a substantially similar manner to that which may typically occur when a user presses a PTT button. Furthermore, in response to receiving an acknowledgment that the floor was granted, the voice-activated floor control mechanism may start an audio stream from the audible frames stored in the RAM or other buffer rather than the current audible frames recorded with the microphone. Relatedly, if the floor was in fact granted, the voice-activated floor control mechanism may continue to monitor the audio to detect silence or other changes in the audio bitrate to infer whether the user intends to release the floor (e.g., in response to detecting silence lasting a duration that exceeds a certain length or other suitable threshold).

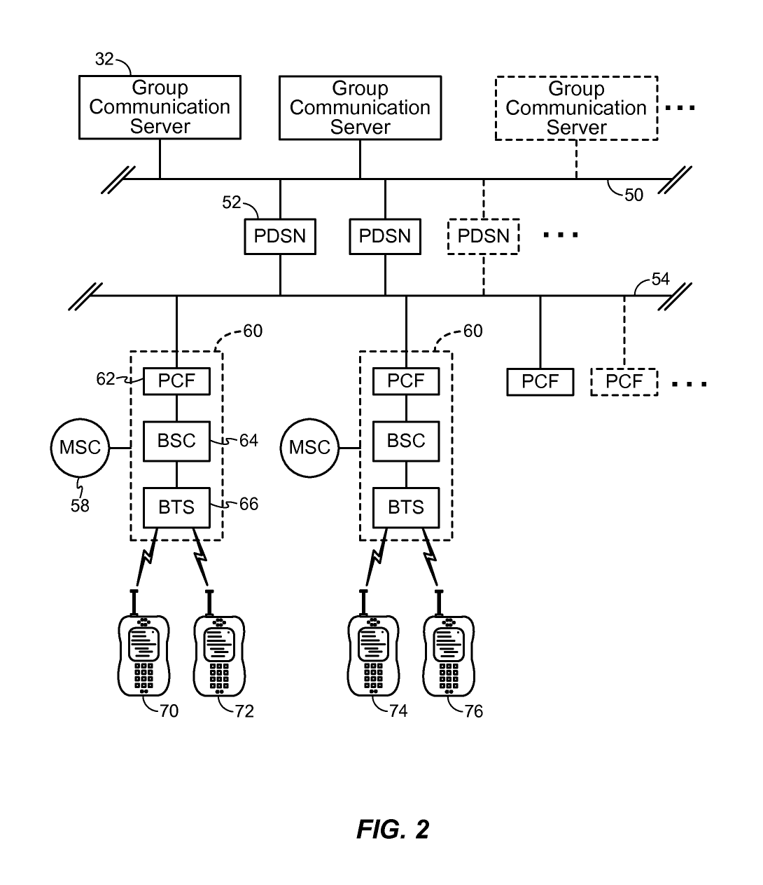

According to one aspect of the disclosure, FIG. 2 illustrates an exemplary block diagram corresponding to one embodiment in which a wireless network in a common cellular configuration may have one or more group communication server 32 that can control communications among wireless telecommunication devices 70, 72, 74, 76, etc. in a PTT group. Furthermore, those skilled in the art will appreciate that the wireless network shown in FIG. 2 is merely exemplary and can include any system in which various remote modules can communicate over-the-air between and among each other and/or between and among components in a wireless network, which may include, without limitation, wireless network carriers and/or servers. In one embodiment, the one or more group communication servers 32 may be connected to a server-side LAN 50 and wireless telecommunication devices 70, 72, 74, 76, etc. can request packet data sessions from the group communication servers 32 using suitable data service options.

In one embodiment, the one or more group communication servers 32 may be connected to a wireless service provider packet data service node (PDSN) 52 that may reside on a carrier network 54, wherein each PSDN 52 can interface with a base station controller (BSC) 64 at a base station 60 through a packet control function (PCF) 62, which may typically be located in the base station 60. The carrier network 54 may control messages, which generally comprise data packets, sent to a messaging service controller (MSC) 58 and communicate with the MSC 58 over a network, the Internet, and/or a plain ordinary telephone system (POTS). In one embodiment, the network or Internet connection between the carrier network 54 and the MSC 58 may typically transfer data, while the POTS may typically transfer voice information. Furthermore, in one embodiment, the MSC 58 can be connected to one or more base stations 60, and in a similar manner to the carrier network 54, the MSC 58 may typically be connected to a branch-to-source (BTS) 66 through the network and/or the Internet to support data transfer and through POTS to support transferring voice information. In one embodiment, the BTS 66 may ultimately broadcast and receive messages wirelessly to and from the wireless telecommunication devices 70, 72, 74, 76, etc. using short messaging service (SMS) or other suitable over-the-air methods. Those skilled in the art will further appreciate that carrier boundaries and/or PTT operator network boundaries do not inhibit or prohibit sharing data in the manner described herein.

In general, cellular telephones and mobile telecommunication devices (e.g., wireless telecommunication devices 70, 72, 74, 76, etc.) are being manufactured with increased computing capabilities and are becoming tantamount to personal computers and hand-held PDAs. These “smart” cellular telephones allow software developers to create software applications that can be downloaded and executed on a processor associated with the wireless telecommunication devices 70, 72, 74, 76, etc. (e.g., web pages, applets, MIDlets, games, data, etc.). Furthermore, in wireless telecommunication devices that have designated a communication group 12 (e.g., as shown in FIG. 1), the wireless communication devices can directly connect with other members in the communication group 12 to engage in voice and data communication. However, all such direct communications will occur typically through, or under the control of, the one or more group communication servers 32. Although all data packets communicated among the wireless telecommunication devices 70, 72, 74, 76, etc. do not necessarily have to travel through the one or more group communication servers 32, in general, the one or more group communication servers 32 will ultimately control the communication because the one or more group communication servers 32 are typically the only components on the server-side LAN 50 that may know and/or retrieve the identities associated with the members in the communication group 12, or direct the identities associated with the members in the communication group 12 to other computer devices.

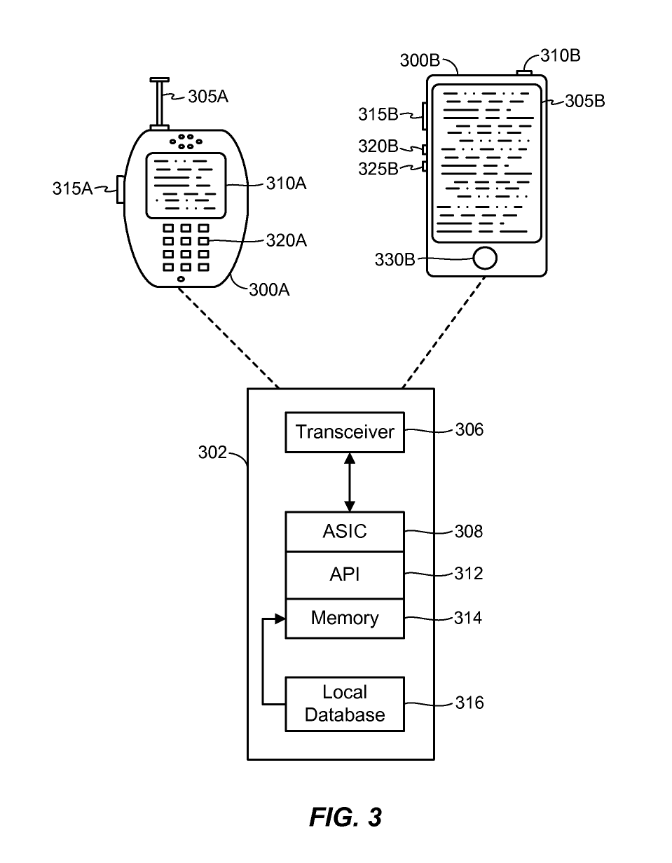

According to one aspect of the disclosure, FIG. 3 illustrates an exemplary block diagram corresponding to one embodiment associated with wireless telecommunication devices having computer platforms that can supports PTT capabilities. In particular, FIG. 3, wireless telecommunication device 300A is illustrated as a calling telephone and wireless telecommunication device 300B is illustrated as a touchscreen device (e.g., a smart phone, a tablet computer, etc.). As shown in FIG. 3, an external casing of wireless telecommunication device 300A is configured with an antenna 305A, display 310A, at least one button 315A (e.g., a PTT button, a power button, a volume control button, etc.) and a keypad 320A among other components, as is known in the art. Also, an external casing of wireless telecommunication device 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. In one embodiment, the PTT button 315A and/or other peripheral buttons 310B, 315B, 320B and 325B may be used to open direct communication to a target set that includes one or more member devices in a communication group 12. However, those skilled in the art will appreciate that other devices and methods can be alternately used to engage in a PTT communication, such as a “soft key” on touch screen display 305B, other methods as known in the art, and/or or the voice-activated floor control mechanisms that will be described in further detail below. Furthermore, in addition to presenting information about ongoing group communications and/or PTT communications, the display 310A and/or 305B can present information that can be used to control or otherwise configure the voice-activated floor control mechanisms described more fully below.

In one embodiment, while not shown explicitly as part of wireless telecommunication device 300B, the wireless telecommunication device 300B can include one or more external antennas and/or one or more integrated antennas that are built into the external casing of wireless telecommunication device 300B, including but not limited to Wi-Fi antennas, cellular antennas, satellite position system (SPS) antennas (e.g., global positioning system (GPS) antennas), and so on, and the wireless telecommunication device 300A may likewise include one or more external and/or integrated antennas in addition to the antenna 305A. In any case, the one or more external and/or integrated antennas (including at least the antenna 305A) can be used to open a direct communication channel with the wireless telecommunication devices 300A and/or 300B and thereby provide a direct communication interface to the wireless telecommunication devices 300A and/or 300B, wherein the direct communication interface may typically comprise hardware known to those skilled in the art. Furthermore, in one embodiment, the direct communication interface can integrate with standard communication interfaces associated with wireless telecommunication devices 300A and/or 300B that are ordinarily used to carry voice and data transmitted to and from the wireless telecommunication devices 300A and/or 300B.

Furthermore, although internal components of wireless telecommunication device 300A and wireless telecommunication device 300B can be embodied with different hardware configurations, FIG. 3 shows a platform 302 that may provide a basic high-level configuration for internal hardware components associated with wireless telecommunication devices 300A and/or 300B. In particular, the platform 302 can generally receive and execute software applications, data and/or commands transmitted from a cellular network that may ultimately come from the core network, the Internet, and/or other remote servers and networks (e.g., an application server, web URLs, etc.). The platform 302 can also independently execute locally stored applications without cellular network interaction. The platform 302 can include a transceiver 306 coupled to an application specific integrated circuit (ASIC) 308, or other processor, microprocessor, logic circuit, or other data processing device. The ASIC 308 or other processor executes the application programming interface (API) 312 layer that interfaces with any application environment resident in the memory 314, which can include the operating system loaded on the ASIC 308 and/or any other resident programs in the memory 314 (e.g., the “binary runtime environment for wireless” (BREW) wireless device software platform developed by QUALCOMM®). The memory 314 can be comprised of read-only memory (ROM) or random-access memory (RAM), electrically erasable programmable ROM (EEPROM), flash cards, or any memory common to computer platforms. The platform 302 also can include a local database 316 that can store applications not actively used in memory 314, as well as other data. The local database 316 is typically a flash memory cell, but can be any secondary storage device as known in the art, such as magnetic media, EEPROM, optical media, tape, soft or hard disk, or the like.

Accordingly, an aspect of the disclosure can include wireless telecommunication devices 300A, 300B, etc. that have the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 314, API 312 and local database 316 may all be used cooperatively to load, store and execute the various functions disclosed herein and thus the logic to perform these functions may be distributed over various elements. Alternatively, the functionality could be incorporated into one discrete component. Furthermore, certain wireless telecommunication devices that may be used in the various embodiments disclosed herein may not include certain components and/or functionalities associated with the wireless telecommunication devices 300A and 300B shown in FIG. 3. For example, certain wireless devices may support PTT communication despite not having a PTT button 315A or other peripheral buttons 310B, 315B, 320B and 325B that can provide a function corresponding to a PTT button 315A (e.g., a smartwatch running a PTT client), whereby wireless devices that support PTT communication despite not having a PTT button 315A or other physical mechanism that can provide a function corresponding thereto may nonetheless achieve substantially the same functionality using the voice-activated floor control mechanisms that will be described in further detail below. However, those skilled in the art will appreciate that the wireless telecommunication devices 300A and 300B shown in FIG. 3 that do have a PTT button 315A or other peripheral buttons 310B, 315B, 320B and 325B that can provide a function corresponding thereto may likewise use and obtain the benefits from the voice-activated floor control mechanisms that will be described in further detail below (e.g., to trigger floor requests, floor releases, and other floor-related functions in a hands-free environment). Therefore, those skilled in the art will appreciate that the features associated with the wireless telecommunication devices 300A and 300B shown in FIG. 3 are merely illustrative and the disclosure is not limited to the illustrated features or arrangements.

The wireless communication between the wireless telecommunication devices 300A and/or 300B can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the wireless telecommunication devices 300A and/or 300B from and using various networks and network configurations. Accordingly, the illustrations provided herein are not intended to limit the aspects of the disclosure and are merely to aid in the description of various aspects disclosed herein.

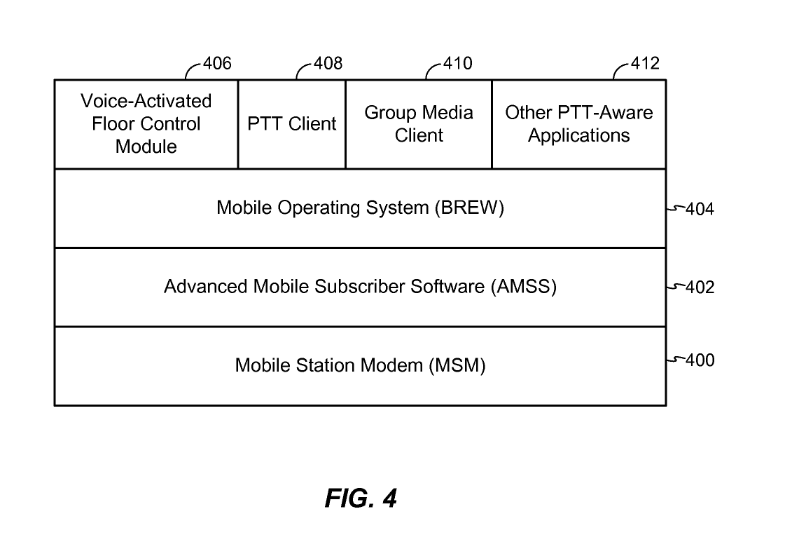

According to one aspect of the disclosure, FIG. 4 illustrates an exemplary block diagram corresponding to one embodiment associated with various software layers that may be included in a group communication application having at least a PTT client 408 and a voice-activated floor control module 406. In particular, the various software layers shown in FIG. 4 may generally be “layered” above a Mobile Station Modem (MSM) 400 and Advanced Mobile Subscriber Software (AMSS) 402, which may implement technologies developed by QUALCOMM®, wherein the various software layers shown in FIG. 4 may drive the underlying chipset associated with the MSM 400 and implement the software protocol stack a CDMA communication technologies suite that include CDMA2000 1X and CDMA2000 1xEV-DO. For example, in one embodiment, a mobile operating system layer 404 (e.g., the BREW® software platform mentioned above) provides one or more application programming interfaces (APIs) for chip-specific and/or device-specific operations, while further providing an isolation layer that eliminates direct contact to the AMSS 402 and any OEM software on the computer platform. The mobile operating system layer 404 enables application development that uses mobile device features without having to rewrite the application each time a new release of the device-specific software is released. However, those skilled in the art will appreciate that other software layer configurations can be alternately used in the computer platform (e.g., Linux®, Windows®, or other operating systems or architectures) to implement the various embodiments disclosed herein.

In one embodiment, the PTT client 408 may generally comprise an application that may offer access to PTT services through an external and/or internal interface (e.g., a PTT-aware user interface). The PTT client includes all the functions required to enable applications that may run on the mobile operating system 404, such as the voice-activated floor control module and the group media client 410. In addition to providing access to PTT services, the PTT client 408 may provide a layer to isolate all PTT-aware applications 412 and interfaces to the group communication server 32. As such, in one embodiment, the PTT client 408 may maintain access to PTT services, respond to group communication requests, process all requests that relate to PTT services from PTT-aware applications 412, process all outgoing PTT requests, collect and package vocoder data packets associated with originated PTT talk spurts, and parse vocoder data packets associated with terminated PTT talk spurts.

In one embodiment, the group media client 410 may generally comprise a mobile operating system-based application that extends PTT services to media types other than traditional half-duplex voice communications (e.g., Voice over Internet Protocol (VoIP)-PTT media), wherein the group media client 410 may provide access to group-media services through the external and/or internal PTT-aware user interface. For example, in one embodiment the PTT-aware user interface may comprise a mobile operating system-based application or an application used in combination with an interface to the AMSS 402. In general, the PTT-aware user interface may invoke the appropriate APIs (e.g., APIs associated with other resident PTT-aware applications 412) in response to user requests that may relate to group-directed media services. The group media client 410 may thereby service the user requests and inform the user about the result associated with any group-directed media requests. Furthermore, in one embodiment, the user can define a setting on the group media client 410 to specify how to handle incoming notifications indicating that a file may be available to download from a file management server (e.g., the data store 36 shown in FIG. 1). For example, in one embodiment, the group media client 410 can be configured to commence the file download immediately or prompt the user about whether or not to download the file.

In one embodiment, as noted above, the software layers shown in FIG. 4 may further include a voice-activated floor control module 406 that may be configured to control a microphone or other hardware mechanisms on the host wireless communication device and communicate with the PTT client 408 to support various PTT services that relate to floor control. For example, in one embodiment, the voice-activated floor control module 406 may activate the microphone to listen to ambient noise during idle states in ongoing PTT group communications and/or when no PTT group communications are ongoing to establish and/or adjust a threshold “bitrate” value that can be used to infer whether a user may be speaking during an ongoing PTT group communication with an intent to take the floor. In addition, voice-activated floor control module 406 may gather and buffer audible frames in RAM or another suitable memory while listening to the ambient noise and performing further analysis in parallel thereto. Accordingly, the buffered ambient noise may be analyzed to infer when the user may be speaking with the intent to take the floor (e.g., when the bitrate rises above and remains above the standing average longer than a particular duration and/or various other factors that will be described more fully below), in response to which the voice-activated floor control module 406 may trigger a floor request in a substantially similar manner to that which may typically occur when a user presses a PTT button. Furthermore, in response to receiving an acknowledgment that the floor was granted, the voice-activated floor control module 406 may start an audio stream from the buffered audible frames rather than the current audible frames recorded with the microphone. Relatedly, if the floor was in fact granted, the voice-activated floor control module 406 may continue to monitor the audio to detect silence or other changes in the audio bitrate to infer whether the user intends to release the floor (e.g., in response to detecting silence lasting a duration that exceeds a certain length or threshold).

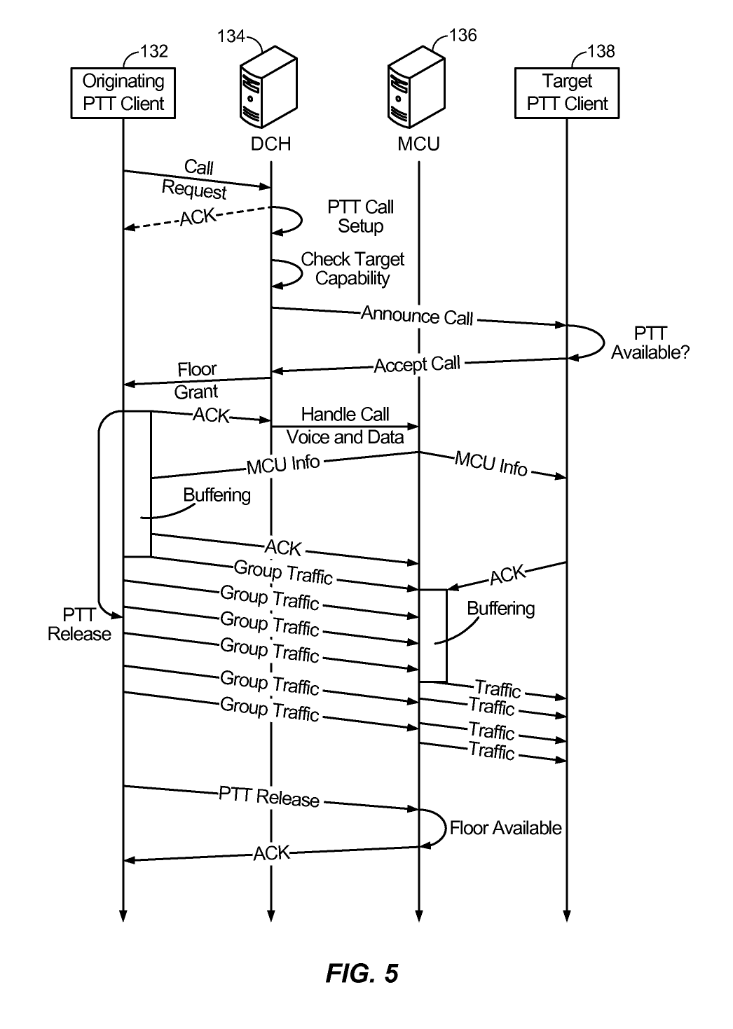

According to one aspect of the disclosure, FIG. 5 illustrates an exemplary call flow corresponding to one embodiment in which a wireless communication device may receive a floor grant in response to initiating a PTT group communication and subsequently release the floor to allow other PTT group members to take the floor. In particular, in response to an originating PTT client 132 requesting a direct PTT call with at least one target device, shown here as having a resident target PTT client 138, the originating PTT client 132 may transmit a call setup request to a Dispatch Call Handler (DCH) 134. For example, in one embodiment, the call setup request may include an address associated with the target device, an application identifier, and/or any other suitable information that may typically be communicated to the DCH 134 to initiate a PTT group call. The DCH 134 may then perform the PTT call setup functions, which may include locating the target device, applying any appropriate call restrictions, selecting a vocoder and assigning a Media Control Unit (MCU) 136 resource. In addition, the DCH 134 may check capabilities associated with the target device to verify that the target device can support the requested PTT communication. In response to suitably verifying that the target device can support the requested PTT communication, the DCH 134 may then send a message announcing the call to the target PTT client 138 associated with the target device, which may transmit a message accepting the PTT call to the DCH 134 in response to determining that PTT communications are available on the target device.

In one embodiment, in response to receiving the acknowledgement accepting the call from the target PTT client 138, the DCH 134 may transmit a floor grant message to the originating PTT client 132, which may indicate that the PTT call is being established and the originating PTT client 132 can start collecting media (e.g., voice data or other appropriate media). As such, the originating PTT client 132 may notify the user that the floor was granted and that the user can therefore start to speak, wherein the originating PTT client 132 may collect and buffer voice media (i.e., the talk spurt collected from the user via the vocoder). In response to the originating PTT client 132 receiving and acknowledging a contact information message from the MCU 136, the buffered voice media (or group traffic) may be sent to the MCU 136, which may likewise buffer the voice media and forward the group traffic to the target PTT client 138 after receiving an acknowledgement to the contact information message from the target PTT client 138. At some subsequent point in time, the originating PTT client 132 may release the initial floor grant and transmit a PTT release message to the MCU 136, which may then release the floor and send a message acknowledging the floor release to the originating PTT client 132. Accordingly, the originating PTT client 132, the target PTT client 138, and/or any other PTT clients that may be participating in the PTT call may take the floor in a substantially similar manner.

Although the foregoing describes the manner in which the floor may be initially granted to the originating PTT client 132 according to how a typical floor control mechanism may operate, those skilled in the art will appreciate that the voice-activated floor control may (or may not) be the mechanism used to control taking and releasing the floor in FIG. 5. Instead, the foregoing description is merely illustrative and intended to provide general background about how the floor may be taken and released when a PTT client originates a PTT call. As such, the following description will provide more substantial detail about how the voice-activated floor control mechanism disclosed herein may be used to control taking the floor, releasing the floor, and providing other functions in relation to managing the floor during a PTT call.

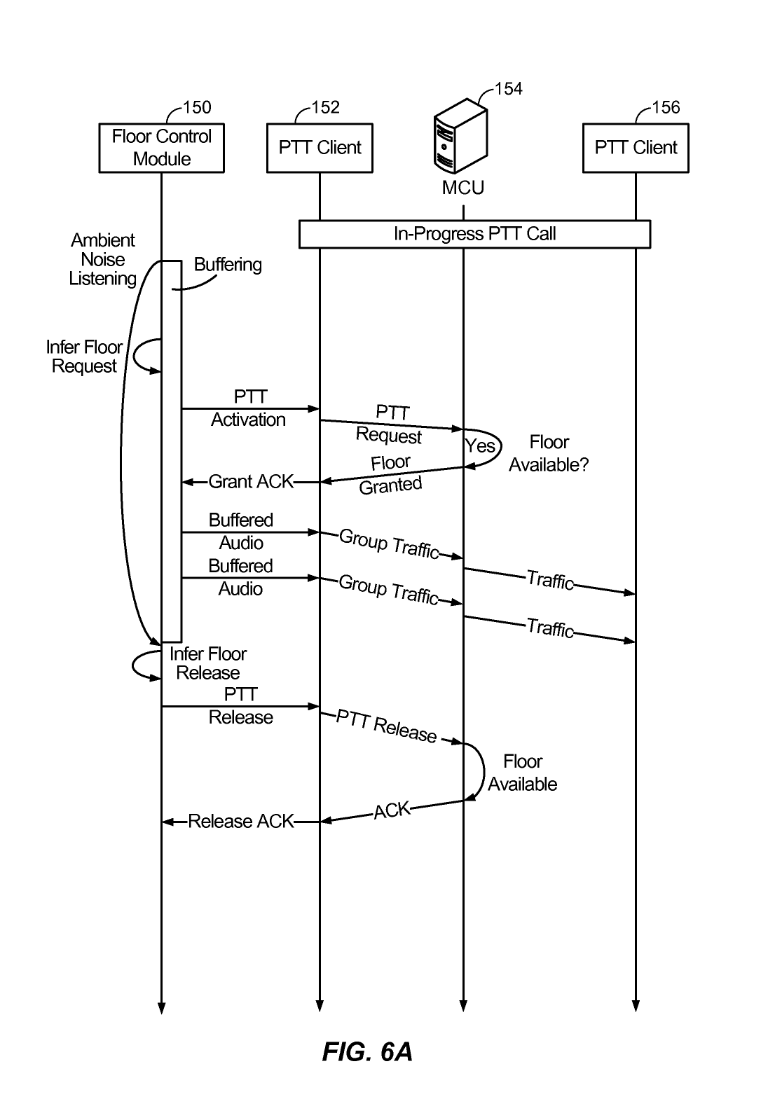

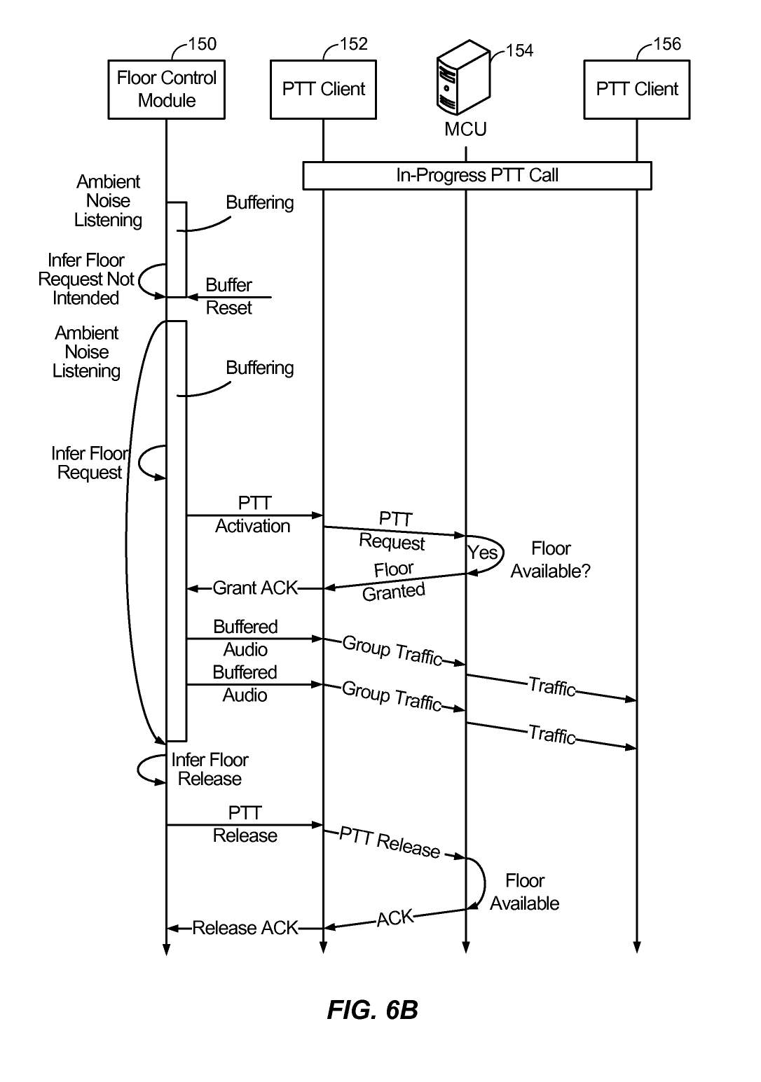

According to one aspect of the disclosure, FIG. 6A illustrates an exemplary call flow corresponding to one embodiment in which a wireless communication device engaged in a PTT group communication may utilize a voice-activated floor control module 150 to request the floor, control audio transmissions while the floor has been granted to the wireless communication device, and subsequently release the floor. However, those skilled in the art will further appreciate that the voice-activated floor control module 150 may be utilized at the time that a wireless communication device originates the PTT group communication.

In particular, when an in-progress PTT call does not exist, or during idle states in an in-progress PTT call, the voice-activated floor control module 150 may listen to the ambient noise and compute the average “bitrate” from the vocoder, wherein silence or normal background noise levels may generally result in the bitrate averaging to the “eighth rate” or comfort noise value. Furthermore, the vocoder may generally filter out noise that does not fall within a particular frequency range typically associated with voice (e.g., between 4-8 kHz). As such, when more substantial background noise exists, the voice-activated floor control module 150 may compute any noise that the vocoder does not already filter out based on the voice frequency range into the average idle bitrate threshold value, which may factor in sound attributable to radio, music, background conversations in public, and other sound that may not represent the user speaking. Furthermore, because the ambient noise conditions will typically change over time, the voice-activated floor control module 150 may compute the standing average bitrate based on the average bitrate over a particular duration (e.g., the most recent 20-60 seconds, although other durations may be suitably used). In any case, in response to the voice-activated floor control module 150 determining that the bitrate associated with the ambient noise rises above the standing average and remains above the standing average during a period that lasts longer than a threshold duration or exceeds a timer value, the voice-activated floor control module 150 may infer that the user was speaking with the intent to take the floor and therefore send a PTT activation message to the PTT client 152 and thereby trigger a floor request from the PTT client 152 to the MCU 154.

Furthermore, in one embodiment, the voice-activated floor control module 150 may adjust or otherwise tune the threshold duration or timer value used to infer whether the user may be speaking with the intent to take the floor based on various different parameters, which may differ based on a context associated with the in-progress PTT call. For example, if the floor has just been released, the voice-activated floor control module 150 may consider that another participant in the PTT call will likely attempt to take the floor immediately because conversations typically proceed in that manner. Accordingly, in response to the PTT client 152 receiving a notification that the floor was released, the PTT client 152 may signal that the floor was released to the voice-activated floor control module 150, which may then shorten the threshold duration used to infer the intent to take the floor. Furthermore, if the voice-activated floor control module 150 does not infer any intent to take the floor and the floor subsequently remains open without other group members taking the floor, the voice-activated floor control module 150 may increase the threshold duration to ensure that background noise and/or background audio will not trigger a false positive.

In another example, the voice-activated floor control module 150 may compare monitored microphone levels and/or other monitored audio levels to ambient noise that was measured upon past floor releases to determine the parameters used to adjust or tune the threshold duration used to infer the intent to take the floor. More particularly, if the microphone generally generates larger audio bitrates in periods immediately after a floor release but someone else takes the floor before the voice-activated floor control module 150 “locks” onto an inference that the floor was requested, the voice-activated floor control module 150 may shorten the threshold duration used the next time that a floor release occurs assuming the bitrate again increases immediately after the next floor release. In other words, because the condition in which the microphone generates larger audio bitrates immediately after a floor release but someone else takes the floor before a floor request inference can be generated likely means that the user keeps trying to take the floor immediately after the floor releases and the voice-activated floor control 150 takes too long to lock onto the floor request interference, the threshold duration used to infer a floor request may be shortened in response to observing that pattern to increase the likelihood that a timely floor request inference can be generated.

In still another example, the voice-activated floor control module 150 may be configured with knowledge about allowable voices to enable the voice-activated floor request, wherein if time permits (e.g., the floor remains available without any other participants in the PTT call taking the floor), the voice-activated floor control module 150 may use voice recognition to confirm that the detected voice signal in fact originates from the user, which may provide a further factor in determining whether a floor request was intended. Relatedly, the voice-activated floor control module 150 may include or be coupled to a speech recognition engine that can identify certain words, phrases, or other relevant information from utterances that are spoken during the PTT call. As such, the speech recognition engine may be used to determine whether any utterances captured from the microphone was spoken with proper grammar, wherein if the utterances were not spoken with proper grammar or otherwise do not seem like a sentence, the voice-activated floor control module 150 may determine that the utterances are probably not a talk spurt from which a floor request can be inferred. Conversely, if the utterances were spoken with proper grammar or seem like a sentence, the voice-activated floor control module 150 the utterances may be more likely to represent a talk spurt from which a floor request can be inferred. In that context, whether a particular utterance may be considered grammatically correct or otherwise likely to represent a talk spurt may depend on the user base and adjusted accordingly (e.g., utterances from a user having a stutter may not seem like a correct sentence when considered out-of-context even though the utterances may in fact be an intended sentence from that user).

In another example, the speech recognition engine included in or coupled to the voice-activated floor control module 150 may be used to identify certain words, phrases, or other utterances that occur during the PTT call. Accordingly, the voice-activated floor control module 150 may consider key words that recently used in the conversation, names or other identities associated with the conversation participants, and/or other contextual parameters to determine whether or not to generate a floor request inference and/or adjust the threshold duration used to generate a floor request inference. As such, in response to detecting one or more key words, names, contexts, or other variables in the sampled ambient noise that match key words, names, contexts, or other variables that were recently used in the conversation, the voice-activated floor control module 150 may increase the likelihood that a floor request inference will be generated and/or shorten the time period required to lock onto the intended floor request. For example, if Mark, Artie, and Mike are participants in the PTT call and Mike says “We should file a patent application” while holding the floor, and if the voice-activated floor control module 150 subsequently detects that Mike released the floor and determines that Mark said “Yes Mike, good idea . . . Artie, please file the patent application” after turning on the microphone on Mark's device, the voice-activated floor control module 150 may infer a floor request because the utterance from Mark included three key words relevant to the conversation (i.e., “Mike,” “Artie,” and “patent application”) in addition to other contextual clues relevant to the conversation (e.g., the word “yes” will typically be said in response to something that someone else said and therefore provides a clue that the utterance relates to what was previously said). Furthermore, because generating the floor request inference after fully recognizing and parsing the utterance may take too long (e.g., someone else may take the floor before the voice-activated floor control module 150 reaches the “patent application” phrase), the voice-activated floor control module 150 generate the floor request inference sooner (e.g., the voice-activated floor control module 150 may only match the “Mike” key word during the first couple seconds, whereas the “Mark” and “Artie” key words may be matched if the threshold duration is slightly longer and all three words may be matched if the threshold duration is even longer, whereby the threshold duration may be progressively decreased in response to each key word match, after a certain number of key word matches, etc.).

In still other examples, the conversation context that the voice-activated floor control module 150 considers may relate to who may be the next person to logically have a turn to speak in the conversation. For example, if Mike and Mark are chatting back and forth and Mike just finishes speaking, the voice-activated floor control module 150 may determine that Mark would be the next person to logically take the floor and therefore use a shorter threshold duration in which to infer the floor request.

Additionally, in one embodiment, the voice-activated floor control module 150 may use third-party services (e.g., the Shazam song recognition service) to filter out certain audio input. For example, a user may be listening to the Michael Jackson song “Thriller” on a car radio, which the third-party service may recognize at the same time that the singing detected via the microphone input may indicate voice in the typical 4-5 kHz human range. Consequently, if certain audio detected via the microphone can be matched to a known song or otherwise recognized using a third-party service, the voice-activated floor control module 150 may discard that audio to avoid triggering a false positive. Alternatively and/or additionally, a component corresponding to the known song audio may be actively removed from the microphone input audio stream and the voice-activated floor control module 150 may again attempt to determine whether a floor request can be inferred from the remaining audio input components.

In one embodiment, as noted above, the voice-activated floor control module 150 may activate the microphone to listen to the ambient noise when an in-progress PTT call does not exist and/or during idle states in an in-progress PTT call (i.e., when a PTT floor does not exist), whereby the voice-activated floor control module 150 may constantly receive audio frames while attempting to lock onto a speech pattern that indicates an intended floor request from the available data (e.g., the bitrate information). Accordingly, if the voice-activated floor control module 150 detects a transition from all silence to a few audible frames, the buffered audio frames will likely not include enough audio data to constitute a genuine intent to take the floor. As such, because the voice-activated floor control module 150 must ensure that enough audio data has been buffered before concluding that the user intends to take the floor, the voice-activated floor control module 150 may “restart” the buffering in response to determining that one or more audible frames do not include a talk spurt from which a floor request can be inferred. For example,

More particularly, FIG. 6B illustrates an exemplary call flow where the voice-activated floor control module 150 may initially sample and buffer audio during an idle state in an in-progress PTT group communication and discard or otherwise reset the buffering in response to generating an inference that the sampled audio does not indicate an intended floor request. Thereafter, the voice-activated floor control module 150 may continue to listen to the ambient noise and determine whether or not the buffered audio indicate an intended floor request in a substantially similar manner. For example, if silence turns into ten audible data frames, which constitutes 200 ms of audio, and the captured audio data subsequently reverts to silence and/or comfort-noise levels after that 200 ms, the voice-activated floor control module 150 may reset the buffering and determine that the user did not intend to take the floor. However, if the 200 ms of audio are followed by 200 ms of silence and then another 300 ms of audio, whereby enough audible frames are built up in the RAM buffer to start looking like word or speech patterns, the voice-activated floor control module 150 may infer that the user intends to take the floor and accordingly trigger the floor request. In that context, depending on an overall required audio threshold (e.g., one second), the voice-activated floor control module 150 may apply one or more latency shedding techniques (e.g., time warping, gap-shortening between words, etc.) and subsequently start streaming the audio from the beginning of the RAM buffer (e.g., one second ago).

In one embodiment, in response to appropriately requesting the floor and streaming the buffered audio during the floor grant, the voice-activated floor control module 150 may then perform various functions to determine whether or not an intent to release the floor can be inferred. For example, in one embodiment, the voice-activated floor control module 150 may simply wait until silence lasting longer than a threshold duration has been observed and infer that the user has finished talking and intends to release the floor at that point. Accordingly, the voice-activated floor control module 150 may follow a general rule to infer a floor release if the monitored audio drops to the comfort noise level (i.e., ⅛ frames) and remains at or below the comfort noise level longer than the threshold duration. However, the general rule may be modified to consider whether ambient noise may be louder than the typical “comfort noise” level, in which case the “comfort noise” level may be increased accordingly. Alternatively, if the current audio bitrate during a talk spurt drops to a threshold level (which may be higher than the comfort noise level) and remains at or below the threshold level longer than another duration that may be longer than the threshold duration associated with the comfort noise level, the voice-activated floor control module 150 may similarly infer a floor release. In other words, the voice-activated floor control module 150 may generally track the audio bitrate throughout the talk spurt and release the floor if the audio bitrate drops to the comfort noise level for a duration that lasts X seconds, or release the floor if the audio bitrate drops to the previous ambient bitrate for Y seconds, wherein Y is greater than X.

Additionally, in one embodiment, the voice-activated floor control module 150 may implement various mechanisms to increase the accuracy associated with floor release inferences. For example, the voice-activated floor control module 150 may use speech recognition to detect when meaningful words end versus gibberish, which again may depend on the particular user who spoke the utterance. In another example, if grammar and/or context may be used, wherein if a speech-to-text translation appears to indicate that a statement has ended, the period to infer a floor release may be shortened, or the period to infer a floor release may alternatively (or additionally) be shortened while the talk spurt duration continues (e.g., essentially taking a more aggressive approach towards releasing the floor if the user pauses after a long talk spurt, whereas a longer silent period may be left before releasing if the talk spurt is still short, such as a four second release timer if the spurt is less than thirty seconds, a three second timer if the spurt is between thirty and ninety seconds, a two second timer if the spurt has lasted longer than 90 seconds, etc.). In still another example, past communal history information may be used, wherein if users within the group communication typically make very short statements and release the floor immediately thereafter, the voice-activated floor control module 150 may apply a comparable release timer setting to floor releases, and conversely, if users in the call tend to babble and release the floor slowly, that context may be considered in determining the release timer setting. For example, if two users tend to each talk for one or two minutes each time that they hold the floor, silence lasting two or three seconds may trigger a floor release and a three second timer may be used in the floor request mode when a different user takes the floor. However, if the two users tend to talk for only a few seconds each time that they hold the floor, a shorter silence may trigger the floor release and a shorter timer may likewise be used in the subsequent floor request mode.

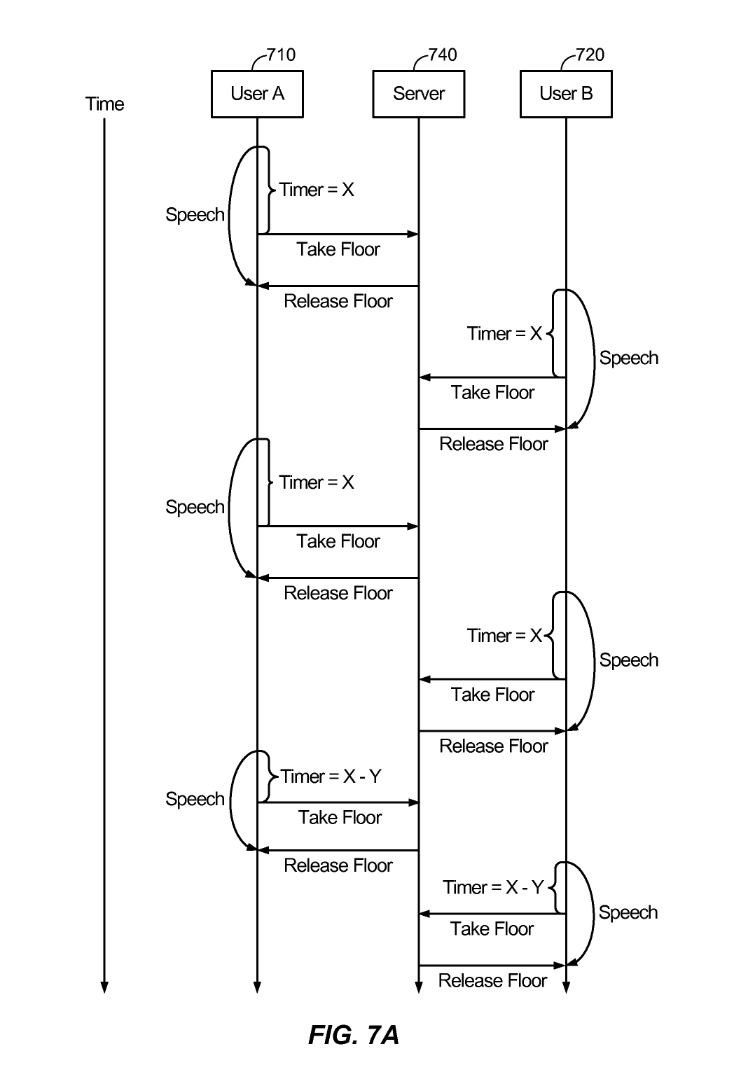

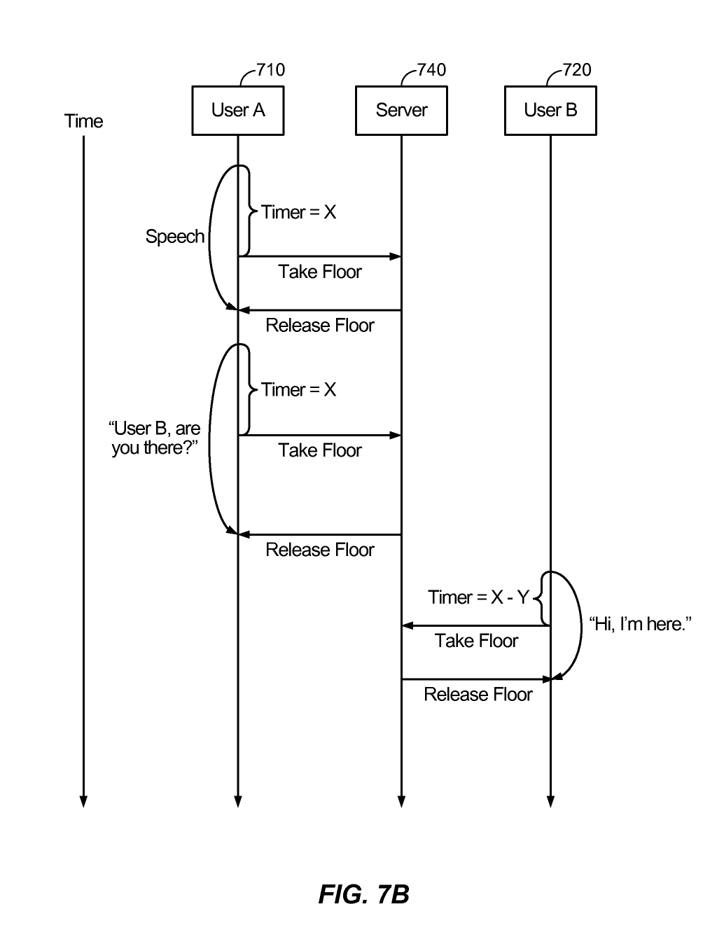

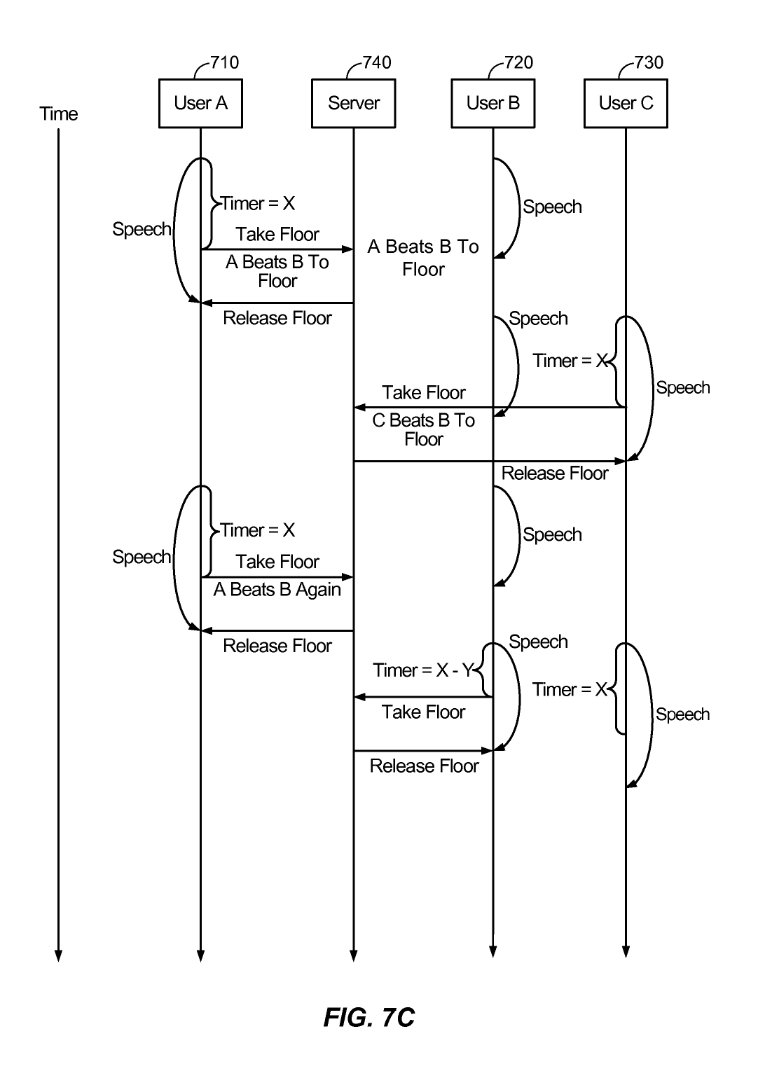

According to various aspects of the disclosure, FIGS. 7A-C illustrate exemplary timing diagrams corresponding to various embodiments in which the voice-activated floor control mechanism described in further detail above may adjust the timer used to trigger the floor request based on a conversational context associated with a PTT call.

More particularly, according to one embodiment, FIG. 7A illustrates an exemplary timing diagram in which the voice-activated floor control mechanism may shorten the value associated with the timer used to trigger the floor request based on cadence matching during a PTT call. For example, as shown in FIG. 7A, participants in a particular PTT call may include User A 710 and User B 720, wherein the floor request timer may initially have a value equal to X and User A 710 and User B 720 may each be participating in the PTT call using an appropriate device that implements the voice-activated floor control mechanism described above. As such, in response to the voice-activated floor control mechanism implemented on the device associated with User A 710 inferring a floor request in response to detecting a speech pattern (e.g., ambient noise that exceeds the threshold value indicating normal background noise levels) that lasts longer than X during an idle state, the voice-activated floor control mechanism implemented on the device associated with User A 710 may transmit a request to take the floor to a server 740 or other suitable network entity that controls floor grants and floor releases during the PTT call. In a similar respect, in response to the voice-activated floor control mechanism implemented on the device associated with User B 720 inferring a floor request in response to detecting a speech pattern that lasts longer than X after the server 740 releases the floor previously granted to User A 710, the voice-activated floor control mechanism implemented on the device associated with User B 720 may transmit a request to take the floor to the server 740.

Accordingly, in response to User A 710 subsequently requesting the floor after the floor granted to User B 720 has been released and User B 720 similarly requesting the floor after a subsequent floor granted to User A 719 has been released, the voice-activated floor control mechanism may infer a conversational context in which User A 710 and User B 720 are talking back and forth and therefore reduce the value associated with the floor request timer due to the expectation that User A 710 will respond to User B 720 after the floor granted to User B 720 has been released and that User B 720 will again respond to User A 710 after the floor granted to User A 710 has been released. In particular, as shown in FIG. 7A, the value associated with the floor request timer may be shortened to X-Y, wherein X and Y may be appropriately expressed in terms of milliseconds, seconds, or any other suitable duration. For example, in one embodiment, X may be one second and Y may be 600 ms, whereby the floor request timer may initially be set to one second and subsequently shortened to 400 ms based on the cadence matching between User A 710 and User B. However, those skilled in the art will appreciate that the above-mentioned values that may be used for X and Y are exemplary only and intended to illustrate how the floor request timer may be shortened based on conversational context, and that other suitable values may be used for X and Y.

According to another embodiment, FIG. 7B illustrates an exemplary timing diagram in which the voice-activated floor control mechanism may shorten the value associated with the floor request timer in response to recognizing one or more key words that relate to one or more specific participants in a PTT call, wherein participants in the PTT call may similarly include User A 710 and User B 720, the floor request timer may similarly have an initial value equal to X, and User A 710 may similarly receive an initial floor grant following a speech pattern that lasts longer than X during an idle state. However, the timing diagram shown in FIG. 7B may differ from the timing diagram shown in FIG. 7A in that a subsequent speech pattern that lasts longer than X may be detected from User A 710 after the server 740 releases the floor initially granted to User A 710 without User B 720 requesting the floor in the interim idle state. Accordingly, as shown in FIG. 7A, the subsequent speech pattern from User A 710 may include the utterance “User B, are you there?” and the voice-activated floor control mechanism implemented on the device associated with User B 720 may detect that “User B” was mentioned in the utterance from User A 710 based on speech recognition performed thereon. As such, the floor request timer associated with User B 720 may be shortened to X-Y because User B 720 may be expected to respond to User A 710 after the server 740 releases the floor that was granted to User A 710 when the “User B, are you there?” utterance was provided. Furthermore, the floor request timer may optionally be shortened further in response to detecting a speech pattern from User B 720 that includes the utterance “Hi, I'm here” (e.g., to X-Z, where Z is greater than Y) because the word “here” may confirm the expectation that User B 720 will respond to User A 710 asking about whether or not User B 720 is present.

According to another embodiment, FIG. 7C illustrates an exemplary timing diagram in which the voice-activated floor control mechanism may shorten the value associated with the floor request timer in response to one or more failed attempts to take the floor during a PTT call, wherein participants in the PTT call may include User A 710, User B 720, and User C 730, the floor request timer may similarly have an initial value equal to X, and User A 710 may similarly receive an initial floor grant following a speech pattern that lasts longer than X during an idle state. However, the timing diagram shown in FIG. 7C may differ from the timing diagrams shown in FIGS. 7A and 7B in that a speech pattern that lasts longer than X may be detected from User B 720 during the initial idle state, meaning that the floor request from User A 710 beat any floor request that may have otherwise been triggered from User B 720. Furthermore, as shown in FIG. 7C, the floor may be granted to User C 730 after the initial floor granted to User A 710 has been released despite User B 720 providing another speech pattern that lasts longer than X after the initial floor granted to User A 710 was released, meaning that the floor request from User C 730 similarly beat any floor request that may have otherwise been triggered from User B 720. Accordingly, in response to User A 710 again taking the floor after the floor granted to User C 730 has been released despite User B 720 again providing a speech pattern that lasts longer than X after the floor granted to User C 730 was released, the floor request timer associated with User B 720 may be shortened to X-Y based on an inference User B 720 has repeatedly attempted to take the floor after a previous floor release and repeatedly failed to take the floor because User A 710 and User C 730 keep beating User B 720 to the floor.

Although the description provided above in relation to FIGS. 7A-7C each the variables X and Y to represent the initial and shortened values that may be used for the floor request timer, those skilled in the art will appreciate that the specific values corresponding to the variables X and Y may be the same or different in each case.

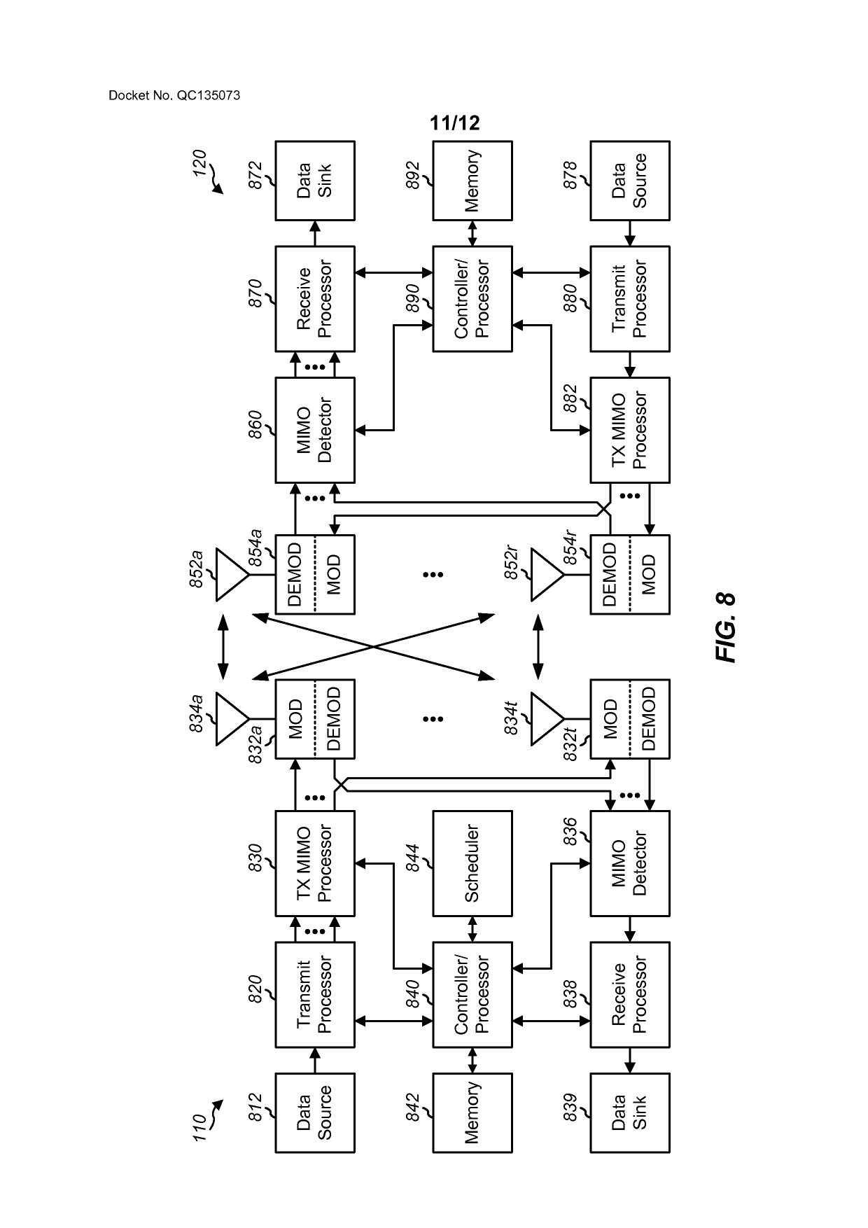

According to one aspect of the disclosure, FIG. 8 illustrates an exemplary block diagram corresponding to one embodiment associated with a base station 110 and a wireless communication device 120, which may be any base station and/or wireless communication device that may communicate with each other in relation to a PTT group communication in relation to the various embodiments disclosed herein. In this design, base station 110 is equipped with T antennas 834a through 834t, and wireless communication device 120 is equipped with R antennas 852a through 852r, where T and R are generally greater than or equal to 1.

At base station 110, a transmit processor 820 may receive data for unicast services and data for broadcast and/or multicast services from a data source 812 (e.g., directly or indirectly from application server 150). Transmit processor 820 may process the data for each service to obtain data symbols. Transmit processor 820 may also receive scheduling information, configuration information, control information, system information and/or other overhead information from a controller/processor 840 and/or a scheduler 844. Transmit processor 820 may process the received overhead information and provide overhead symbols. A transmit (TX) multiple-input multiple-output (MIMO) processor 830 may multiplex the data and overhead symbols with pilot symbols, process (e.g., precode) the multiplexed symbols, and provide T output symbol streams to T modulators (MOD) 832a through 832t. Each modulator 832 may process a respective output symbol stream (e.g., for OFDM) to obtain an output sample stream. Each modulator 832 may further process (e.g., convert to analog, amplify, filter, and upconvert) the output sample stream to obtain a downlink signal. T downlink signals from modulators 832a through 832t may be transmitted via T antennas 834a through 834t, respectively.

At wireless communication device 120, antennas 852a through 852r may receive the downlink signals from base station 110 and provide received signals to demodulators (DEMOD) 854a through 854r, respectively. Each demodulator 854 may condition (e.g., filter, amplify, downconvert, and digitize) a respective received signal to obtain received samples and may further process the received samples (e.g., for OFDM) to obtain received symbols. A MIMO detector 860 may receive and process the received symbols from all R demodulators 854a through 854r and provide detected symbols. A receive processor 870 may process the detected symbols, provide decoded data for wireless communication device 120 and/or desired services to a data sink 872, and provide decoded overhead information to a controller/processor 890. In general, the processing by MIMO detector 860 and receive processor 870 is complementary to the processing by TX MIMO processor 830 and transmit processor 820 at base station 110.

On the uplink, at wireless communication device 120, data from a data source 878 and overhead information from a controller/processor 890 may be processed by a transmit processor 880, further processed by a TX MIMO processor 882 (if applicable), conditioned by modulators 854a through 854r, and transmitted via antennas 852a through 852r. At base station 110, the uplink signals from wireless communication device 120 may be received by antennas 834, conditioned by demodulators 832, detected by a MIMO detector 836, and processed by a receive processor 838 to obtain the data and overhead information transmitted by wireless communication device 120.

Controllers/processors 840 and 890 may direct the operation at base station 110 and wireless communication device 120, respectively. Scheduler 844 may schedule wireless communication devices for downlink and/or uplink transmission, schedule transmission of broadcast and multicast services, and provide assignments of radio resources for the scheduled wireless communication devices and services. Controller/processor 840 and/or scheduler 844 may generate scheduling information and/or other overhead information for the broadcast and multicast services.

Controller/processor 890 may implement processes for the techniques described herein. Memories 842 and 892 may store data and program codes for base station 110 and wireless communication device 120, respectively. Accordingly, group communications can be accomplished in accordance with the various embodiments disclosed herein, while still remaining compliant with the existing standards.

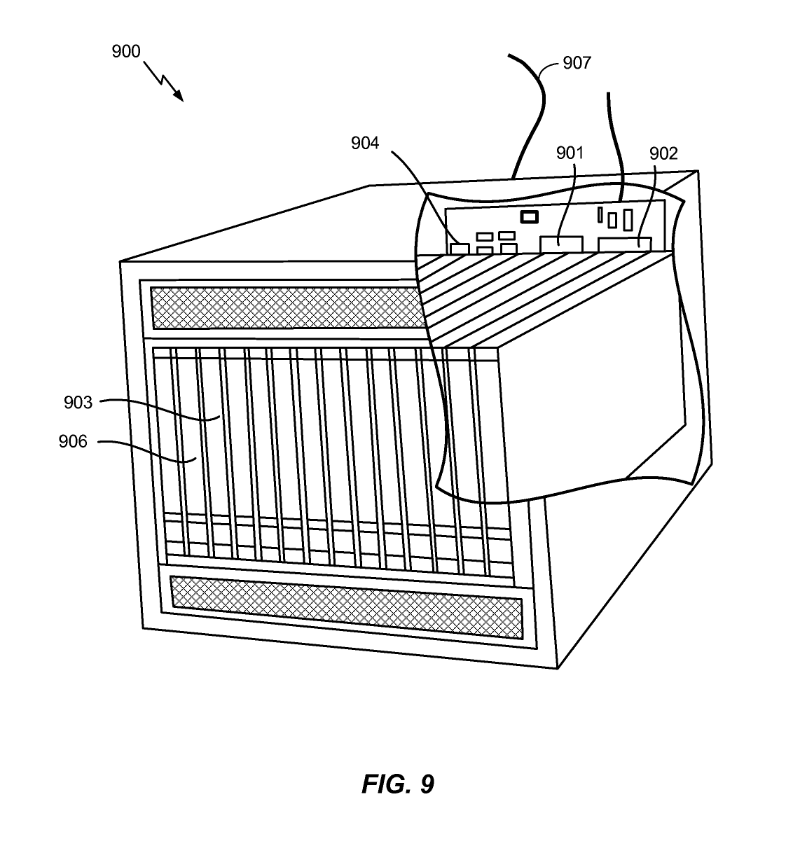

According to one aspect of the disclosure, FIG. 9 illustrates an exemplary block diagram corresponding to one embodiment associated with a server 900 (e.g., the group communication server shown in FIG. 1 and FIG. 2) that may control communications among wireless telecommunication devices in a designated PTT group in accordance with the various embodiments disclosed herein. In one example, the server 900 may be one exemplary configuration corresponding to the MSC, the DCH, the MCU, and/or any other network entity described above. As shown in FIG. 9, the server 900 may include a processor 901 coupled to volatile memory 902 and a large capacity nonvolatile memory (e.g., a disk drive 903). The server 900 may also include a floppy disc drive, compact disc (CD) or DVD disc drive 906 coupled to the processor 901. The server 900 may also include network access ports 904 coupled to the processor 901 for establishing data connections with a network 907, such as a local area network coupled to other broadcast system computers and servers or to the Internet. Furthermore, in one embodiment in context with FIG. 3 and/or FIG. 8, those skilled in the art will appreciate that the server 900 shown in FIG. 9 may correspond to one exemplary implementation of the wireless communication devices 300A, 300B, and/or 120 shown in FIG. 3 and/or FIG. 8, which may transmit and/or receive information using components that may correspond to the network access points 904 used by the server 900 to communicate with the network 907, process information using components that may correspond to the processor 901, and store information using components that may correspond to any combination of the volatile memory 902, the disk drive 903 and/or the disc drive 906. Accordingly, FIG. 9 helps to demonstrate that the wireless communication devices 300A and 300B shown in FIG. 3 and/or the wireless communication device 120 shown in FIG. 8 may be implemented as a server, in addition to a wireless communication device implementation as shown in FIG. 3 and FIG. 8.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, etc.).

The methods, actions, and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for voice-activated push-to-talk (PTT) floor control, comprising:
listening to ambient noise during an idle state in a PTT call;
comparing a bitrate associated with the ambient noise during the idle state to a threshold value that indicates normal background noise levels; and
triggering a request to take a floor in the PTT call in response to the bitrate associated with the ambient noise during the idle state exceeding the threshold value and continuing to exceed the threshold value until a floor request timer expires.

2. The method recited in claim 1, further comprising:
shortening the floor request timer in response to determining that a participant in the PTT call that was holding the floor has released the floor.

3. The method recited in claim 2, further comprising:
increasing the floor request timer in response to determining that the released floor has remained available for a predetermined time period without another participant taking the floor.

4. The method recited in claim 1, further comprising:
performing voice recognition to confirm that the ambient noise having the bitrate that exceeded the threshold value originated from a user utterance.

5. The method recited in claim 1, further comprising:
determining that a first participant in the PTT call that was holding the floor released the floor and that a second participant in the PTT call subsequently requested and took the floor; and
shortening the floor request timer in response to determining that the bitrate associated with the ambient noise exceeded the threshold value during a period after the first participant released the floor and prior to the second participant requesting and taking the floor.

6. The method recited in claim 1, further comprising:
shortening the floor request timer in response to recognizing one or more key words that match a conversational context associated with the PTT call within the ambient noise.

7. The method recited in claim 1, further comprising:
triggering the request to take the floor in response to recognizing one or more key words that match a conversational context associated with the PTT call within the ambient noise.

8. The method recited in claim 1, further comprising:
determining that a first participant in the PTT call released the floor; and
triggering the request to take the floor based on a conversational context indicating a next logical user to have a turn to speak in the PTT call.

9. The method recited in claim 1, further comprising:
determining whether to trigger the request to take the floor based on whether one or more key words recognized within the ambient noise indicate proper grammar.

10. The method recited in claim 1, further comprising:
removing audio that matches a known audio sample from the ambient noise.

11. The method recited in claim 1, further comprising:
gathering audible frames that correspond to the ambient noise in a buffer; and
resetting the audible frames gathered in the buffer in response to determining that the ambient noise does not indicate an intent to request the floor.

12. The method recited in claim 1, further comprising:
gathering audible frames that correspond to the ambient noise in a buffer;
applying one or more latency shredding techniques to the audible frames gathered in buffer in response to the ambient noise triggering the request to take the floor; and
streaming the audible frames gathered in buffer from a start of the buffer subsequent to applying the one or more latency shredding techniques.

13. The method recited in claim 1, further comprising:
continuing to listen to the ambient noise after the request to take the floor has been triggered and during a floor grant;
comparing the bitrate associated with the ambient noise during the floor grant to a threshold value that indicates a comfort noise level; and
triggering a request to release the floor in response to the bitrate associated with the ambient noise during the floor grant dropping below the threshold value that indicates the comfort noise level and staying below the threshold value until a first floor release timer expires.

14. The method recited in claim 13, further comprising:
triggering the request to release the floor in response to the bitrate associated with the ambient noise during the floor grant dropping below the threshold value that indicates the normal background noise levels and staying below the threshold value that indicates the normal background noise levels until a second floor release timer expires, wherein the second floor release timer is longer than the first floor release timer; and
adjusting one or more of the first floor release timer or the second floor release timer based on a conversational context associated with the PTT call.

15. An apparatus for voice-activated push-to-talk (PTT) floor control, comprising:
means for listening to ambient noise during an idle state in a PTT call;
means for comparing a bitrate associated with the ambient noise during the idle state to a threshold value that indicates normal background noise levels; and
means for triggering a request to take a floor in the PTT call in response to the bitrate associated with the ambient noise during the idle state exceeding the threshold value and continuing to exceed the threshold value until a floor request timer expires.

16. The apparatus recited in claim 15, further comprising:
means for shortening the floor request timer in response to determining that a participant in the PTT call that was holding the floor has released the floor.

17. The apparatus recited in claim 16, further comprising:
means for increasing the floor request timer in response to determining that the released floor has remained available for a predetermined time period without another participant taking the floor.

18. The apparatus recited in claim 15, further comprising:
means for performing voice recognition to confirm that the ambient noise having the bitrate that exceeded the threshold value originated from a user utterance.

19. The apparatus recited in claim 15, further comprising:
means for determining that a first participant in the PTT call that was holding the floor released the floor and that a second participant in the PTT call subsequently requested and took the floor; and
means for shortening the floor request timer in response to determining that the bitrate associated with the ambient noise exceeded the threshold value during a period after the first participant released the floor and prior to the second participant requesting and taking the floor.

20. The apparatus recited in claim 15, further comprising:
means for shortening the floor request timer in response to recognizing one or more key words that match a conversational context associated with the PTT call within the ambient noise.

21. The apparatus recited in claim 15, further comprising:
means for triggering the request to take the floor in response to recognizing one or more key words that match a conversational context associated with the PTT call within the ambient noise.

22. The apparatus recited in claim 15, further comprising:
means for determining that a first participant in the PTT call released the floor; and
means for triggering the request to take the floor based on a conversational context indicating a next logical user to have a turn to speak in the PTT call.

23. The apparatus recited in claim 15, further comprising:
means for determining whether to trigger the request to take the floor based on whether one or more key words recognized within the ambient noise indicate proper grammar.

24. The apparatus recited in claim 15, further comprising:
means for removing audio that matches a known audio sample from the ambient noise.

25. The apparatus recited in claim 15, further comprising:
means for gathering audible frames that correspond to the ambient noise in a buffer; and
means for resetting the audible frames gathered in the buffer in response to determining that the ambient noise does not indicate an intent to request the floor.

26. The apparatus recited in claim 15, further comprising:
means for gathering audible frames that correspond to the ambient noise in a buffer;
means for applying one or more latency shredding techniques to the audible frames gathered in buffer in response to the ambient noise triggering the request to take the floor; and
means for streaming the audible frames gathered in buffer from a start of the buffer subsequent to applying the one or more latency shredding techniques.

27. The apparatus recited in claim 15, further comprising:
means for continuing to listen to the ambient noise after the request to take the floor has been triggered and during a floor grant;
means for comparing the bitrate associated with the ambient noise during the floor grant to a threshold value that indicates a comfort noise level; and
means for triggering a request to release the floor in response to the bitrate associated with the ambient noise during the floor grant dropping below the threshold value that indicates the comfort noise level and staying below the threshold value until a first floor release timer expires.

28. The apparatus recited in claim 27, further comprising:
means for triggering the request to release the floor in response to the bitrate associated with the ambient noise during the floor grant dropping below the threshold value that indicates the normal background noise levels and staying below the threshold value that indicates the normal background noise levels until a second floor release timer expires, wherein the second floor release timer is longer than the first floor release timer; and
means for adjusting one or more of the first floor release timer or the second floor release timer based on a conversational context associated with the PTT call.

29. An apparatus for voice-activated push-to-talk (PTT) floor control, comprising:
an audio capture device configured to capture ambient noise during an idle state in a PTT call; and
a processor configured to compare a bitrate associated with the ambient noise during the idle state to a threshold value that indicates normal background noise levels and trigger a request to take a floor in the PTT call in response to the bitrate associated with the ambient noise during the idle state exceeding the threshold value and continuing to exceed the threshold value until a floor request timer expires.

30. A computer-readable storage medium having computer-executable instructions recorded thereon, wherein executing the computer-executable instructions on one or more processors causes the one or more processors to:
listen to ambient noise during an idle state in a push-to-talk (PTT) call;
compare a bitrate associated with the ambient noise during the idle state to a threshold value that indicates normal background noise levels; and
trigger a request to take a floor in the PTT call in response to the bitrate associated with the ambient noise during the idle state exceeding the threshold value and continuing to exceed the threshold value until a floor request timer expires.
